(19) United States
(12) Patent Application Publication
(10) Pub. No.: US 2017/0308953 A1
(43) Pub. Date: Oct. 26, 2017

(54) METHOD for PROCESSING USER CONSUMPTION DATA AND SERVER

(71) Applicant: FENGLIANG YAN, YINCHUAN (CN)

(72) Inventor: FENGLIANG YAN, YINCHUAN (CN)

(21) Appl. No.: 15/448,548

(22) Filed: Mar. 2, 2017

Related U.S. Application Data
(63) Continuation of application No. PCT/CN2016/080147, filed on Apr. 25, 2016.

(51) Int. Cl. G06Q 40/04

(52) U.S. Cl. CPC G06Q 40/04

(57) ABSTRACT

The present invention provide a method for processing user consumption data and a server, where the method includes: a server acquires a first numerical value corresponding to consumption data of a user; the server determines information about a first trading commodity to be exchanged according to the first numerical value, and updates account information of the user according to the information about the first trading commodity; the server receives a transaction request message transmitted by the user, and processes the updated account information of the user according to the transaction request message. Thus, data processing efficiency, flexibility and accuracy are improved.

### CROSS-REFERENCE TO RELATED APPLICATIONS

This application is a continuation of International Application No. PCT/CN2016/080147, filed on Apr. 25, 2016, the disclosure of which is hereby incorporated by reference in its entirety.

### TECHNICAL FIELD

Embodiments of the present invention relate to data processing technologies and, in particular, to a method for processing user consumption data and a server.

### BACKGROUND

In recent years, methods for processing user consumption data employ a manner of numerical rebate, and the numerical rebate has been a common mode used by companies, for instance, a company determines a corresponding numerical value according to user's consumption data, and the user may exchange a commodity having a corresponding value using the determined numerical value, or discount the determined numerical value, or the user may participate in a raffle organized by the company when the numerical values owned by the user reach a preset threshold.

In summary, the numerical rebate mode in the prior art is a manual numerical rebate mode, which has low efficiency and lacks flexibility and accuracy.

### SUMMARY

Embodiments of the present invention provide a method for processing user consumption data and a server, which, thus, improve efficiency of data processing, and flexibility and accuracy of the data processing.

In a first aspect, an embodiment of the present invention provides a method for processing user consumption data, including: acquiring, by a server, a first numerical value corresponding to consumption data of a user;

determining, by the server, information about a first trading commodity to be exchanged according to the first numerical value, where the information about the first trading commodity includes: an identification of the first trading commodity and a first share of the first trading commodity exchanged according to the first numerical value;

updating, by the server, account information of the user according to the information about the first trading commodity;

receiving, by the server, a transaction request message transmitted by the user, where the transaction request message includes the identification of the first trading commodity, an operation type corresponding to the first trading commodity and a second share of the first trading commodity corresponding to the operation type, where the operation type corresponding to the first trading commodity is: buy or sell; and

processing, by the server, the updated account information of the user according to the transaction request message.

Alternatively, the determining, by the server, the information about the first trading commodity to be exchanged according to the first numerical value includes:

determining, by the server, an attribute parameter of the first numerical value and a numerical value corresponding to each share of the first trading commodity;

determining, by the server, the identification of the first trading commodity according to the attribute parameter of the first numerical value, and determining the first share of the first trading commodity according to the numerical value corresponding to each share of the first trading commodity,

where the attribute parameter of the first numerical value includes: an identification of a company which generates the first numerical value.

Alternatively, the updating, by the server, the account information of the user according to the information about the first trading commodity includes:

if the account information of the user includes the identification of the first trading commodity, then updating, by the server, a share of the first trading commodity held by the user in the account information of the user according to the first share of the first trading commodity;

if the account information of the user does not include the identification of the first trading commodity, then adding, by the server, the identification of the first trading commodity into the account information of the user, and determining the first share of the first trading commodity as the share of the first trading commodity held by the user.

Alternatively, the processing, by the server, the updated account information of the user according to the transaction request message includes:

if the operation type corresponding to the first trading commodity is the buy, then allocating, by the server, the second share of the first trading commodity to the account of the user to update the share of the first trading commodity held by the user;

if the operation type corresponding to the first trading commodity is the sell, then exchanging, by the server, the second share of the first trading commodity for capital information, and allocating the capital information to the account of the user to update the share of the first trading commodity held by the user.

Alternatively, after the processing, by the server, the updated account information of the user according to the transaction request message, the method further includes:

if the server determines that the share of the first trading commodity held by the user before the updating is greater than a first preset value, and that the share of the first trading commodity held by the user after the updating is less than a second preset value,

then determining, by the server, a second numerical value corresponding to the share of the first trading commodity held by the user after the updating, and determining, according to the second numerical value, information about a second trading commodity to be exchanged, where the information about the second trading commodity includes: an identification of the second trading commodity and a third share of the second trading commodity exchanged according to the second numerical value; and

updating, by the server, the updated account information of the user according to the information about the second trading commodity again.

In a second aspect, an embodiment of the present invention provides a server, including: an acquiring module, which is configured to acquire a first numerical value corresponding to consumption data of a user;

a determining module, which is configured to determine information about a first trading commodity to be exchanged according to the first numerical value, where the information about the first trading commodity includes: an identification of the first trading commodity and a first share of the first trading commodity exchanged according to the first numerical value;

an updating module, which is configured to update account information of the user according to the information about the first trading commodity;

a receiving module, which is configured to receive a transaction request message transmitted by the user, where the transaction request message includes the identification of the first trading commodity, an operation type corresponding to the first trading commodity and a second share of the first trading commodity corresponding to the operation type, where the operation type corresponding to the first trading commodity is: buy or sell; and

a processing module, which is configured to process the updated account information of the user according to the transaction request message.

Alternatively, the determining module is specifically configured to:

determine an attribute parameter of the first numerical value and a numerical value corresponding to each share of the first trading commodity;

determine the identification of the first trading commodity according to the attribute parameter of the first numerical value, and determine the first share of the first trading commodity according to the numerical value corresponding to each share of the first trading commodity,

where the attribute parameter of the first numerical value includes: an identification of a company which generates the first numerical value.

Alternatively, the updating module is specifically configured to update a share of the first trading commodity held by the user in the account information of the user according to the first share of the first trading commodity, if the account information of the user includes the identification of the first trading commodity;

if the account information of the user does not include the identification of the first trading commodity, then the updating module is specifically configured to add the identification of the first trading commodity into the account information of the user, and determine the first share of the first trading commodity as the share of the first trading commodity held by the user.

Alternatively, the processing module is specifically configured to:

the processing module allocates the second share of the first trading commodity to the account of the user to enable the updating module to update the share of the first trading commodity held by the user, if the operation type corresponding to the first trading commodity is the buy;

if the operation type corresponding to the first trading commodity is the sell, then the processing module exchanges the second share of the first trading commodity for capital information, and allocates the capital information to the account of the user to enable the updating module to update the share of the first trading commodity held by the user.

Alternatively, if the determining module determines that the share of the first trading commodity held by the user before the updating is greater than a first preset value, and that the share of the first trading commodity held by the user after the updating is less than a second preset value,

then the determining module is further configured to: determine a second numerical value corresponding to the share of the first trading commodity held by the user after the updating, and determine, according to the second numerical value, information about a second trading commodity to be exchanged, where the information about the second trading commodity includes: an identification of the second trading commodity and a third share of the second trading commodity exchanged according to the second numerical value; and

the updating module is further configured to update the updated account information of the user according to the information about the second trading commodity again.

In a third aspect, an embodiment of the present invention provides a server, including: a processor, a memory and a receiver;

where the memory is configured to store executable instructions of the processor;

the processor is configured to:

acquire a first numerical value corresponding to consumption data of a user;

determine information about a first trading commodity to be exchanged according to the first numerical value, where the information about the first trading commodity includes: an identification of the first trading commodity and a first share of the first trading commodity exchanged according to the first numerical value;

update account information of the user according to the information about the first trading commodity;

the receiver is configured to receive a transaction request message transmitted by the user, where the transaction request message includes the identification of the first trading commodity, an operation type corresponding to the first trading commodity and a second share of the first trading commodity corresponding to the operation type, where the operation type corresponding to the first trading commodity is: buy or sell; and

the processor is further configured to process the updated account information of the user according to the transaction request message.

Alternatively, the processor is specifically configured to:

determine an attribute parameter of the first numerical value and a numerical value corresponding to each share of the first trading commodity;

determine the identification of the first trading commodity according to the attribute parameter of the first numerical value, and determine the first share of the first trading commodity according to the numerical value corresponding to each share of the first trading commodity;

where the attribute parameter of the first numerical value includes: an identification of a company which generates the first numerical value.

Alternatively, the processor is specifically configured to update a share of the first trading commodity held by the user in the account information of the user according to the first share of the first trading commodity, if the account information of the user includes the identification of the first trading commodity;

if the account information of the user does not include the identification of the first trading commodity, then the processor is specifically configured to add the identification of the first trading commodity into the account information of the user, and determine the first share of the first trading commodity as the share of the first trading commodity held by the user.

Alternatively, the processor is specifically configured to allocate the second share of the first trading commodity to the account of the user to update the share of the first trading commodity held by the user, if the operation type corresponding to the first trading commodity is the buy;

if the operation type corresponding to the first trading commodity is the sell, then the processor is specifically configured to exchange the second share of the first trading commodity for capital information, and allocate the capital information to the account of the user to update the share of the first trading commodity held by the user.

Alternatively, if the processor determines that the share of the first trading commodity held by the user before the updating is greater than a first preset value, and that the share of the first trading commodity held by the user after the updating is less than a second preset value,

the processor is further configured to:

determine a second numerical value corresponding to the share of the first trading commodity held by the user after the updating, and determine, according to the second numerical value, information about a second trading commodity to be exchanged, where the information about the second trading commodity includes: an identification of the second trading commodity and a third share of the second trading commodity exchanged according to the second numerical value; and

update the updated account information of the user according to the information about the second trading commodity again.

Embodiments of the present invention provide a method for processing user consumption data and a server, where the method includes: acquiring, by the server, a first numerical value corresponding to consumption data of a user; determining, by the server, information about a first trading commodity to be exchanged according to the first numerical value, and updating account information of the user according to the information about the first trading commodity; receiving, by the server, a transaction request message transmitted by the user, and processing the updated account information of the user according to the transaction request message. The method for processing user consumption data has higher data processing efficiency in relative to the mode of manual numerical rebate in the prior art, meanwhile, by means of processing the transaction request message transmitted by the user, the server achieves buy or sell performed by the user for a trading commodity to enable the method for processing user consumption data to have higher flexibility, and furthermore, the method for processing user consumption data has improved accuracy.

### BRIEF DESCRIPTION OF DRAWINGS

In order to make technical solutions in embodiments of the present invention or the prior art more clear, accompanying drawings used for description of the embodiments or the prior art will be briefly described hereunder. Obviously, the described drawings below are merely some embodiments of present invention. For persons of ordinary skill in the art, other drawings may be obtained based on these drawings without any creative effort.

FIG. 1 is a flow chart of a method for processing user consumption data according to an embodiment of the present invention;

FIG. 2 is a flow chart of determining information about a first trading commodity according to an embodiment of the present invention;

FIG. 3 is a flow chart where a server updates account information of the user according to the information about the first trading commodity according to an embodiment of the present invention;

FIG. 4 is a flow chart where the server processes the updated account information of the user according to a transaction request message according to an embodiment of the present invention;

FIG. 5 is a schematic structural diagram of a server according to an embodiment of the present invention;

FIG. 6 is a schematic structural diagram of a server according to another embodiment of the present invention.

### DESCRIPTION OF EMBODIMENTS

The technical solutions in the embodiments of the present invention will be described hereunder clearly and completely with reference to the accompanying drawings in the embodiments of the present invention. Obviously, the described embodiments are only a part of embodiments of the present invention, rather than all embodiments of the present invention. All other embodiments obtained by persons of ordinary skill in the art based on the embodiments of the present invention without any creative effort shall fall into the protection scope of the present invention.

Terms such as “first” and “second” in the description, claims and accompanying drawings of the present invention are used for distinguishing similar objects, rather than describing a particular sequence or order. It should be noted that the data used therefrom are interchangeable under appropriate circumstances, such that the embodiments of the present invention described herein can be implemented in a sequence in addition to those illustrated or described herein. Moreover, terms such as “comprising/including”, “having” and any variants thereof are intended to cover nonexclusive inclusions, for instance, procedures or methods including a series of steps, systems, products or devices including a series of units or modules, which are not limited to those steps or units that are clearly illustrated, but may also include other steps or units that are not clearly illustrated or are inherent to those procedures, methods, products or devices. The expression of “at least one” involved in the present invention means one or more.

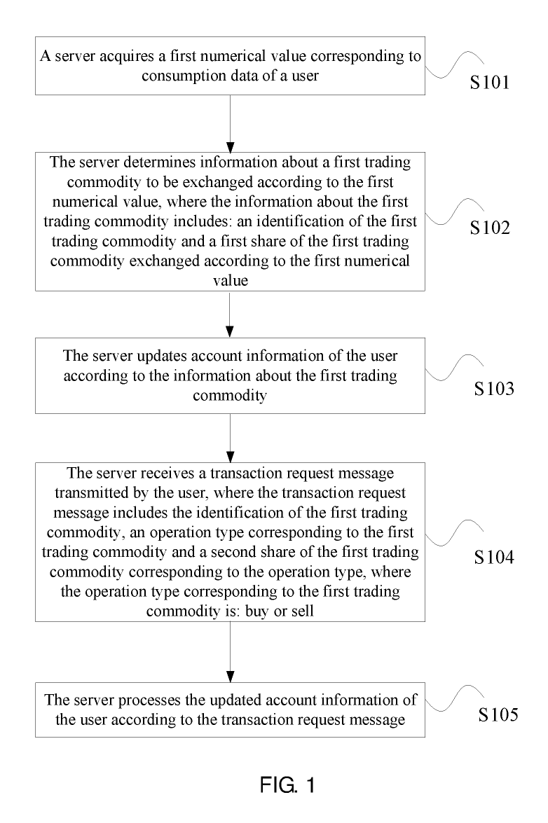

In order to solve the problem in the prior art, where the numerical rebate mode is a manual numerical rebate mode and such mode has low efficiency and lacks flexibility and accuracy, embodiments of the present invention provide a method for processing user consumption data and a server, where an executive body of the method is the server, and an application scenario of the method is that: a user performs consumption in a company, and generates corresponding user consumption data. FIG. 1 is a flow chart of a method for processing user consumption data according to an embodiment of the present invention, and as shown in FIG. 1, the method includes processes of:

Step S101: a server acquires a first numerical value corresponding to consumption data of a user;

In embodiments of the present invention, the numerical value may be accumulated points, or may be coupons. The first numerical value corresponding to the consumption data of the user is determined according to a current exchange standard of the company, for instance, the user performs consumption in Company A, the corresponding consumption data is RMB 1000 yuan, and then the company determines that the corresponding first numerical value is 10 accumulated points according to the consumption data RMB 1000 yuan of the user.

The server acquiring the first numerical value corresponding to the consumption data of the user, includes: the server transmits a request message to a terminal in the company, where the request message is configured to request to acquire the first numerical value corresponding to the consumption data of the user, and the request message carries a user identification used for identifying the user; the server receives a response message transmitted by the terminal in the company, where the response message includes the first numerical value corresponding to the consumption data of the user.

Or, the server acquiring the first numerical value corresponding to the consumption data of the user, includes: the terminal in the company transmits a message to the server directly, where the message includes the first numerical value corresponding to the consumption data of the user.

It should be noted that, the communication performed between the server and the terminal in the company may use a manner of direct communication, and may also be a manner of indirect communication which uses an intermediate device for forwarding. Both the manner of direct communication and the manner of indirect communication are performed based on a transmission control protocol/an internet protocol (Transmission Control Protocol/Internet Protocol, TCP/IP for short).

Step S102: the server determines information about a first trading commodity to be exchanged according to the first numerical value, where the information about the first trading commodity includes: an identification of the first trading commodity and a first share of the first trading commodity exchanged according to the first numerical value;

Descriptions continue to be made in terms of the example of the step S101, for instance, the identification of the first trading commodity is charge1, assuming that each share of the first trading commodity corresponds to 5 accumulated points, then the first share of the first trading commodity which the server exchanges according to the first numerical value of 10 accumulated points is 10 accumulated points/5 accumulated points=2.

For one company, the server may determine at least one trading commodity for it finally.

Step S103: the server updates account information of the user according to the information about the first trading commodity;

The account information of the user before the updating includes: an account number of the user, an identification and a share of each trading commodity held by the user.

Step S104: the server receives a transaction request message transmitted by the user, where the transaction request message includes the identification of the first trading commodity, an operation type corresponding to the first trading commodity and a second share of the first trading commodity corresponding to the operation type, where the operation type corresponding to the first trading commodity is: buy or sell;

For instance, when the operation type corresponding to the first trading commodity is buy, a second share of the first trading commodity corresponding to the buy is 3, that is, the user buys 3 shares of first trading commodity; when the operation type corresponding to the first trading commodity is sell, a second share of the first trading commodity corresponding to the sell is 1, that is, the user sells 1 share of first trading commodity.

Step S105: the server processes the updated account information of the user according to the transaction request message.

The server updates a share of the first trading commodity held by the user in the updated account information of the user according to the transaction request message.

The embodiment of the present invention provides a method for processing user consumption data, including: a server acquires a first numerical value corresponding to consumption data of a user; the server determines information about a first trading commodity to be exchanged according to the first numerical value, and updates account information of the user according to the information about the first trading commodity; the server receives a transaction request message transmitted by the user, and processes the updated account information of the user according to the transaction request message. The method for processing user consumption data has higher data processing efficiency in relative to the mode of manual numerical rebate in the prior art, meanwhile, by means of processing the transaction request message transmitted by the user, the server achieves buy or sell performed by the user for a trading commodity to enable the method for processing user consumption data to have higher flexibility, and furthermore, during the above process, the server may acquire the first numerical value corresponding to the consumption data of the user accurately, and may accurately determine the information about the first trading commodity via the first numerical value, and may also timely and accurately process the transaction request message transmitted by the user, hence, the method has more accuracy compared to the prior art.

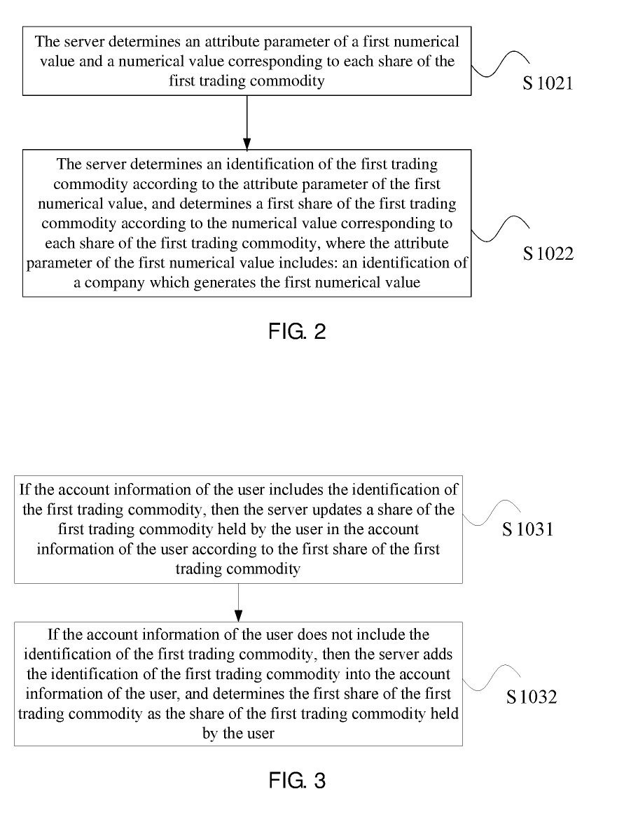

Furthermore, FIG. 2 is a flow chart of determining information about a first trading commodity according to an embodiment of the present invention, as shown in FIG. 2, the step S102 described above includes specifically:

Step S1021: the server determines an attribute parameter of a first numerical value and a numerical value corresponding to each share of the first trading commodity;

Step S1022: the server determines an identification of the first trading commodity according to the attribute parameter of the first numerical value, and determines a first share of the first trading commodity according to the numerical value corresponding to each share of the first trading commodity, where the attribute parameter of the first numerical value includes: an identification of a company which generates the first numerical value.

For instance, the user performs consumption in Company A, and the identification of Company A is company1; the corresponding consumption data is RMB 1000 yuan, the company determines the corresponding first numerical value as 10 accumulated points according to the consumption data RMB 1000 yuan of the user, and the first numerical value corresponding to the consumption data of the user is determined according to a current exchange standard of the company, where the attribute parameter of the first numerical value of 10 accumulated points includes: the identification company1 of the company which generates the first numerical value, the server determines the identification of the first trading commodity as charge1 according to the identification company1. Assuming that a numerical value corresponding to each share of the first trading commodity is 5 accumulated points, then the first share of the first trading commodity which the server exchanges according to the first numerical value of 10 accumulated points is 10 accumulated points/5 accumulated points=2.

In this embodiment, the server may accurately determine an identification of the first trading commodity and a first share of the first trading commodity by determining the attribute parameter of the first numerical value and the numerical value corresponding to each share of the first trading commodity.

Furthermore, FIG. 3 is a flow chart where a server updates account information of the user according to the information about the first trading commodity according to an embodiment of the present invention. As shown in FIG. 3, the step S103 described above includes specifically:

Step S1031: if the account information of the user includes the identification of the first trading commodity, then the server updates a share of the first trading commodity held by the user in the account information of the user according to the first share of the first trading commodity.

For instance, the account information of the user before the updating includes: the identification charge1 and the share 30 of the first trading commodity held by the user. For instance, in table 1, the account number of the user is user1, and the identification and the share of the trading commodity held by the user currently are respectively: charge1, the share is 30; charge2, the share is 10; charge3, the share is 20.

TABLE 1

| | The identification of the trading | The share of the trading |
|---|---|---|
| user1 | commodity | commodity held by the user |
| | charge1 | 30 |
| | charge2 | 10 |
| | charge3 | 20 |

The server updates the account information of the user according to the information about the first trading commodity, and the updated account information of the user is shown in Table 2.

TABLE 2

| | The identification of the trading | The share of the trading |
|---|---|---|
| user1 | commodity | commodity held by the user |
| | charge1 | 32 |
| | charge2 | 10 |
| | charge3 | 20 |

The share of the first trading commodity held by the user after the updating is sum of the share of the first trading commodity held by the user before the updating and the first share.

Step S1032: if the account information of the user does not include the identification of the first trading commodity, then the server adds the identification of the first trading commodity into the account information of the user, and determines the first share of the first trading commodity as the share of the first trading commodity held by the user.

For instance, the account information of the user before the updating does not include: the identification charge1 and the share of the first trading commodity held by the user. For instance, in table 3, the account number of the user is user1, and the identification and the share of the trading commodity held by the user currently are respectively: charge2, the share is 10; charge3, the share is 20.

TABLE 3

| | The identification of the trading | The share of the trading |
|---|---|---|
| user1 | commodity | commodity held by the user |
| | charge2 | 10 |
| | charge3 | 20 |

The server updates the account information of the user according to the information about the first trading commodity, and the updated account information of the user is shown in Table 4.

TABLE 4

| | The identification of the trading | The share of the trading |
|---|---|---|
| user1 | commodity | commodity held by the user |
| | charge2 | 10 |
| | charge3 | 20 |
| | charge1 | 2 |

It should be noted that, actually, the server may perform either the step S1031 or the step S1032, instead of performing both steps simultaneously, and there is no order limit between these two steps.

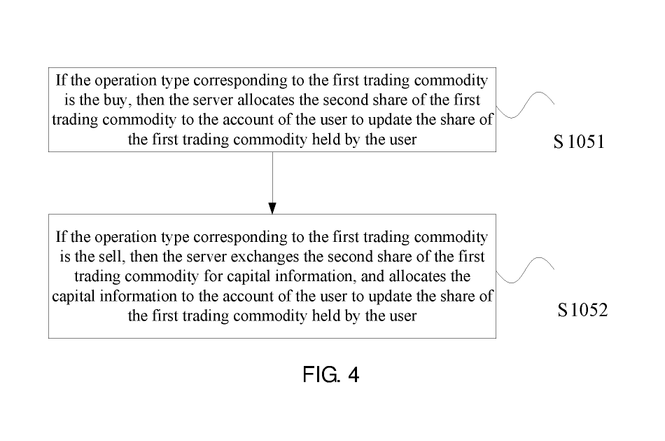

Alternatively, FIG. 4 is a flow chart where the server processes the updated account information of the user according to a transaction request message according to an embodiment of the present invention. As shown in FIG. 4, the step S105 described above includes specifically:

Step S1051: if the operation type corresponding to the first trading commodity is buy, then the server allocates the second share of the first trading commodity to the account of the user to update the share of the first trading commodity held by the user;

Step S1052: if the operation type corresponding to the first trading commodity is the sell then the server exchanges the second share of the first trading commodity for capital information, and allocates the capital information to the account of the user to update the share of the first trading commodity held by the user.

Specifically, for the circumstance in Table 4, assuming that the operation type corresponding to the first trading commodity is buy, and the second share is 3, then the server allocates 3 shares of first trading commodity to the account of the user to update the share of the first trading commodity held by the user, reference may be made to Table 5 for details.

TABLE 5

| | The identification of the trading | The share of the trading |
|---|---|---|
| user1 | commodity | commodity held by the user |
| | charge2 | 10 |
| | charge3 | 20 |
| | charge1 | 5 |

It is obtained according to sum of the share 2 of the first trading commodity charge1 held by the user before the updating and the second share 3 that, the share of the first trading commodity charge1 held by the user after the updating is 5.

For the circumstance in Table 4, assuming that the operation type corresponding to the first trading commodity is sell, and the second share is 1, then the server exchanges the first trading commodity of which the second share is 1 for capital information, and allocates the capital information to the account of the user to update the share of the first trading commodity held by the user. Assuming that a current capital exchange standard of the company is: each share is exchanged for RRM 10 yuan in cash, then the second share 1 may be exchanged for RMB 10 yuan in cash, correspondingly, it is obtained according to difference between the share 2 of the first trading commodity charge1 held by the user before the updating and the second share 1 that, the share of the first trading commodity charge1 held by the user after the updating is 1, reference may be made to Table 6 for details.

TABLE 6

| | The | | |
|---|---|---|---|
| | identification of the | The share of the trading | |
| user1 | trading commodity | commodity held by the user | Cash |
| | charge2 | 10 | RMB 0 yuan |
| | charge3 | 20 | RMB 0 yuan |
| | charge1 | 1 | RMB 10 yuan |

In this embodiment, the server may update account information of the user according to the transaction request message of the user timely and accurately, thereby improving overall accuracy of the method for processing user consumption data of the user.

It should be noted that, actually, the server may perform either the step S1051 or the step S1052, instead of performing both steps simultaneously, and there is no order limit between these two steps.

Furthermore, after the step S105, the method for processing user consumption data further includes:

If the server determines that the share of the first trading commodity held by the user before the updating is greater than a first preset value, and that the share of the first trading commodity held by the user after the updating is less than a second preset value, then the server determines a second numerical value corresponding to the share of the first trading commodity held by the user after the updating, and determines, according to the second numerical value, information about a second trading commodity to be exchanged, where the information about the second trading commodity includes: an identification of the second trading commodity and a third share of the second trading commodity exchanged according to the second numerical value; and the server updates the updated account information of the user according to the information about the second trading commodity again.

The first preset value is greater than the second preset value, and both the first preset value and the second preset value are set by the server according to a practical situation, for instance, the server sets the first preset value as: 90% of the total share of the first trading commodity when the server generates the first trading commodity for the first time; the server sets the second preset value as: 40% of the total share of the first trading commodity, once the server determines that the share of the first trading commodity held by the user before the updating is greater than the first preset value, and that the share of the first trading commodity held by the user after the updating is less than the second preset value, then the user firstly determines the share of the first trading commodity held by the user after the updating, and successively determines a second numerical value corresponding to the share, the second numerical value is usually different from the first numerical value for two reasons: first, during a transaction process performed by the user to the first trading commodity, a change occurs in the share of the first trading commodity held by the user; second, with changes of the exchange standard of the company and market fluctuations, a value parameter of the numerical value is also changing, the so-called value parameter of the numerical value is determined by how many cash the numerical value may be exchanged for.

After the server determines a second numerical value, the server determines, according to the second numerical value, the information about the second trading commodity to be exchanged, where the information about the second trading commodity is information about a new trading commodity, including: an identification of the second trading commodity and a third share of the second trading commodity exchanged according to the second numerical value; and the server updates the updated account information of the user according to the information about the second trading commodity again. Next, the server may continue to acquire a numerical value corresponding to consumption data of the user, and then perform a process similar to the steps S102˜S105; or, the server may perform a process similar to the steps S104˜S105.

It should be noted that, the above process is actually a process where the server orders the first trading commodity to exit a trading platform and a second trading commodity to participate in the trading platform.

In this embodiment, the server may determine whether the share of the first trading commodity held by the user before the updating is greater than a first preset value, and determines whether the share of the first trading commodity held by the user after the updating is less than a second preset value, if both conditions are satisfied, then the server determines a second numerical value, and determines, according to the second numerical value, information about a second trading commodity to be exchanged, rather than continuing to process transactions performed by the user to the first trading commodity, thereby improving flexibility of data processing and improving accuracy of data processing.

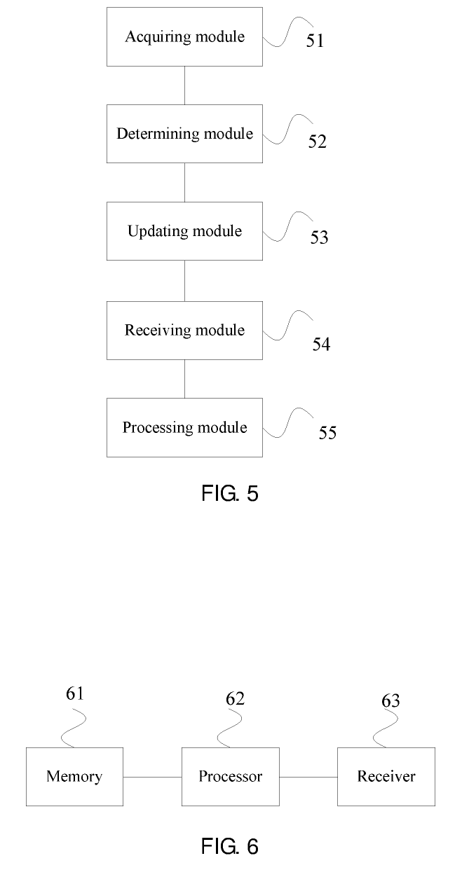

FIG. 5 is a schematic structural diagram of a server according to an embodiment of the present invention, as shown in FIG. 5, the server includes: an acquiring module 51, which is configured to acquire a first numerical value corresponding to consumption data of a user; a determining module 52, which is configured to determine information about a first trading commodity to be exchanged according to the first numerical value, where the information about the first trading commodity includes: an identification of the first trading commodity and a first share of the first trading commodity exchanged according to the first numerical value; an updating module 53, which is configured to update account information of the user according to the information about the first trading commodity; a receiving module 54, which is configured to receive a transaction request message transmitted by the user, where the transaction request message includes the identification of the first trading commodity, an operation type corresponding to the first trading commodity and a second share of the first trading commodity corresponding to the operation type, where the operation type corresponding to the first trading commodity is: buy or sell; and a processing module 55, which is configured to process the updated account information of the user according to the transaction request message.

The server in this embodiment may be used to perform technical solutions of method embodiments as shown in FIG. 1, of which implementation principles and technical effects are similar to those of the technical solutions of the method embodiments as shown in FIG. 1, and will not be repeated herein.

Alternatively, the determining module 52 is specifically configured to: determine an attribute parameter of the first numerical value and a numerical value corresponding to each share of the first trading commodity; determine an identification of the first trading commodity according to the attribute parameter of the first numerical value, and determine a first share of the first trading commodity according to the numerical value corresponding to each share of the first trading commodity, where the attribute parameter of the first numerical value includes: an identification of a company which generates the first numerical value.

The determining module may be used to perform technical solutions of method embodiments as shown in FIG. 2, of which implementation principles and technical effects are similar to those of the technical solutions of the method embodiments as shown in FIG. 2, and will not be repeated herein.

Alternatively, the updating module 53 is specifically configured to update a share of the first trading commodity held by the user in the account information of the user according to the first share of the first trading commodity if the account information of the user includes the identification of the first trading commodity;

The updating module is specifically configured to add the identification of the first trading commodity into the account information of the user, and determine the first share of the first trading commodity as the share of the first trading commodity held by the user, if the account information of the user does not include the identification of the first trading commodity.

The updating module may be used to perform technical solutions of method embodiments as shown in FIG. 3, of which implementation principles and technical effects are similar to those of the technical solutions of the method embodiments as shown in FIG. 3, and will not be repeated herein.

Alternatively, the processing module 55 is specifically configured to: allocate the second share of the first trading commodity to the account of the user if the operation type corresponding to the first trading commodity is buy, to enable the updating module to update the share of the first trading commodity held by the user; if the operation type corresponding to the first trading commodity is the sell, then the processing module exchanges the second share of the first trading commodity for capital information, and allocates the capital information to the account of the user, to enable the updating module to update the share of the first trading commodity held by the user.

The processing module may be used to perform technical solutions of method embodiments as shown in FIG. 4, of which implementation principles and technical effects are similar to those of the technical solutions of the method embodiments as shown in FIG. 4, and will not be repeated herein.

Furthermore, if the determining module 52 determines that the share of the first trading commodity held by the user before the updating is greater than a first preset value, and that the share of the first trading commodity held by the user after the updating is less than a second preset value, then the determining module 52 is further configured to: determine a second numerical value corresponding to the share of the first trading commodity held by the user after the updating, and determine, according to the second numerical value, information about a second trading commodity to be exchanged, where the information about the second trading commodity includes: an identification of the second trading commodity and a third share of the second trading commodity exchanged according to the second numerical value.

The updating module 53 is further configured to update the updated account information of the user according to the information about the second trading commodity again.

The determining module and the updating module may be used to perform corresponding steps of methods after the step S105, of which implementation principles and technical effects are similar to those of the corresponding steps of the methods after the step S105, and will not be repeated herein.

FIG. 6 is a schematic structural diagram of a server according to another embodiment of the present invention, as shown in FIG. 6, the server includes: a processor 61, a memory 62 and a receiver 63.

The memory 62 is configured to store an executable instruction of the processor;

The processor 61 is configured to:

acquire a first numerical value corresponding to consumption data of a user;

determine information about a first trading commodity to be exchanged according to the first numerical value, where the information about the first trading commodity includes: an identification of the first trading commodity and a first share of the first trading commodity exchanged according to the first numerical value;

update account information of the user according to the information about the first trading commodity;

The receiver 63 is configured to receive a transaction request message transmitted by the user, where the transaction request message includes the identification of the first trading commodity, an operation type corresponding to the first trading commodity and a second share of the first trading commodity corresponding to the operation type, where the operation type corresponding to the first trading commodity is: buy or sell;

The processor 62 is further configured to process the updated account information of the user according to the transaction request message.

The server in this embodiment may be used to perform technical solutions of method embodiments as shown in FIG. 1, of which implementation principles and technical effects are similar to those of the technical solutions of the method embodiments as shown in FIG. 1, and will not be repeated herein.

Alternatively, the processor 62 is specifically configured to: determine an attribute parameter of the first numerical value and a numerical value corresponding to each share of the first trading commodity; determine the identification of the first trading commodity according to the attribute parameter of the first numerical value, and determine the first share of the first trading commodity according to the numerical value corresponding to each share of the first trading commodity; where the attribute parameter of the first numerical value includes: an identification of a company which generates the first numerical value.

The processor may be used to perform technical solutions of method embodiments as shown in FIG. 2, of which implementation principles and technical effects are similar to those of the technical solutions of the method embodiments as shown in FIG. 2, and will not be repeated herein.

Alternatively, the processor 62 is specifically configured to update a share of the first trading commodity held by the user in the account information of the user according to the first share of the first trading commodity if the account information of the user includes the identification of the first trading commodity;

If the account information of the user does not include the identification of the first trading commodity, then the processor 62 is specifically configured to add the identification of the first trading commodity into the account information of the user, and determine the first share of the first trading commodity as the share of the first trading commodity held by the user.

The processor may be used to perform technical solutions of method embodiments as shown in FIG. 3, of which implementation principles and technical effects are similar to those of the technical solutions of the method embodiments as shown in FIG. 3, and will not be repeated herein.

Alternatively, the processor 62 is specifically configured to allocate the second share of the first trading commodity to the account of the user to update the share of the first trading commodity held by the user if the operation type corresponding to the first trading commodity is the buy;

If the operation type corresponding to the first trading commodity is the sell, then the processor is specifically configured to exchange the second share of the first trading commodity for capital information, and allocate the capital information to the account of the user to update the share of the first trading commodity held by the user.

The processor may be used to perform technical solutions of method embodiments as shown in FIG. 4, of which implementation principles and technical effects are similar to those of the technical solutions of the method embodiments as shown in FIG. 4, and will not be repeated herein.

Furthermore, if the processor 62 determines that the share of the first trading commodity held by the user before the updating is greater than a first preset value, and that the share of the first trading commodity held by the user after the updating is less than a second preset value, then the processor 62 is further configured to:

determine a second numerical value corresponding to the share of the first trading commodity held by the user after the updating, and determine, according to the second numerical value, information about a second trading commodity to be exchanged, where the information about the second trading commodity includes: an identification of the second trading commodity and a third share of the second trading commodity exchanged according to the second numerical value; and

update the updated account information of the user according to the information about the second trading commodity again.

The processor may be used to perform corresponding steps of methods after the step S105, of which implementation principles and technical effects are similar to those of the corresponding steps of the methods after the step S105, and will not be repeated herein.

In several embodiments provided in the present invention, it should be understood that the disclosed device and method may be implemented in other manners. For example, the described device embodiment is merely exemplary. For example, division of the units is merely logical function division and there may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the devices or units may be implemented in electronic, mechanical, or other forms.

The units described as separate parts may or may not be physically separate, and parts displayed as units may or may not be physical units, that is, may be located in one position, or may be distributed on a plurality of network units. A part or all of the units may be selected according to actual needs to achieve objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of a hardware plus software functional unit.

The integrated unit implemented in the form of the software functional unit may be stored in a computer-readable storage medium. The described software functional unit is stored in a storage medium, and includes several instructions enabling a computer device (which may be a personal computer, a server, or a network device) or a processor to perform a part of steps of the methods described in the embodiments of the present invention. The foregoing storage medium includes: any medium that can store program codes, such as a USB flash disk, a mobile hard disk, a read-only memory (Read-Only Memory, ROM for short), a random access memory (Random Access Memory, RAM for short), a magnetic disk, or an optical disc.

It may be clearly understood by persons skilled in the art that, for the purpose of convenient and brief description, division of the described functional modules is merely described for illustrations, in practical use, the described functions may be assigned as desired to different functional modules for implementations, that is, the internal structure of the device is divided into different functional modules to implement all or a part of functions as described above. For a detailed working process of the described device, reference may be made to corresponding process in the foregoing method embodiments, and details will not be described herein.

Finally, it should be noted that the foregoing embodiments are merely intended for describing the technical solutions of the present invention other than limiting the present invention. Although the present invention is described in detail with reference to the foregoing embodiments, persons of ordinary skill in the art should understand that they may still make modifications to the technical solutions described in the foregoing embodiments, or make equivalent replacements to some or all technical features therein; however, these modifications or replacements do not make the essence of corresponding technical solutions depart from the scope of the technical solutions in the embodiments of the present invention.

What is claimed is:

1. A method for processing user consumption data, comprising:
acquiring, by a server, a first numerical value corresponding to consumption data of a user;
determining, by the server, information about a first trading commodity to be exchanged according to the first numerical value, wherein the information about the first trading commodity comprises: an identification of the first trading commodity and a first share of the first trading commodity exchanged according to the first numerical value;
updating, by the server, account information of the user according to the information about the first trading commodity;
receiving, by the server, a transaction request message transmitted by the user, wherein the transaction request message comprises the identification of the first trading commodity, an operation type corresponding to the first trading commodity and a second share of the first trading commodity corresponding to the operation type, wherein the operation type corresponding to the first trading commodity is: buy or sell; and
processing, by the server, the updated account information of the user according to the transaction request message.

2. The method according to claim 1, wherein the determining, by the server, the information about the first trading commodity to be exchanged according to the first numerical value comprises:
determining, by the server, an attribute parameter of the first numerical value and a numerical value corresponding to each share of the first trading commodity;
determining, by the server, the identification of the first trading commodity according to the attribute parameter of the first numerical value, and determining the first share of the first trading commodity according to the numerical value corresponding to each share of the first trading commodity,
wherein the attribute parameter of the first numerical value comprises: an identification of a company which generates the first numerical value.

3. The method according to claim 1, wherein the updating, by the server, the account information of the user according to the information about the first trading commodity comprises:
updating, by the server, a share of the first trading commodity held by the user in the account information of the user according to the first share of the first trading commodity, if the account information of the user comprises the identification of the first trading commodity;
adding, by the server, the identification of the first trading commodity into the account information of the user and determining the first share of the first trading commodity as the share of the first trading commodity held by the user, if the account information of the user does not comprise the identification of the first trading commodity.

4. The method according to claim 2, wherein the updating, by the server, the account information of the user according to the information about the first trading commodity comprises:
updating, by the server, a share of the first trading commodity held by the user in the account information of the user according to the first share of the first trading commodity, if the account information of the user comprises the identification of the first trading commodity;
adding, by the server, the identification of the first trading commodity into the account information of the user and determining the first share of the first trading commodity as the share of the first trading commodity held by the user, if the account information of the user does not comprise the identification of the first trading commodity.

5. The method according to claim 3, wherein the processing, by the server, the updated account information of the user according to the transaction request message comprises:
allocating, by the server, the second share of the first trading commodity to the account of the user to update the share of the first trading commodity held by the user, if the operation type corresponding to the first trading commodity is the buy;
exchanging, by the server, the second share of the first trading commodity for capital information and allocating the capital information to the account of the user to update the share of the first trading commodity held by the user, if the operation type corresponding to the first trading commodity is the sell.

6. The method according to claim 4, wherein the processing, by the server, the updated account information of the user according to the transaction request message comprises:
allocating, by the server, the second share of the first trading commodity to the account of the user to update the share of the first trading commodity held by the user, if the operation type corresponding to the first trading commodity is the buy;
exchanging, by the server, the second share of the first trading commodity for capital information and allocating the capital information to the account of the user to update the share of the first trading commodity held by the user, if the operation type corresponding to the first trading commodity is the sell.

7. The method according to claim 5, wherein after the processing, by the server, the updated account information of the user according to the transaction request message, the method further comprises:
if the server determines that the share of the first trading commodity held by the user before the updating is greater than a first preset value, and that the share of the first trading commodity held by the user after the updating is less than a second preset value,
determining, by the server, a second numerical value corresponding to the share of the first trading commodity held by the user after the updating, and determining, according to the second numerical value, information about a second trading commodity to be exchanged, wherein the information about the second trading commodity comprises: an identification of the second trading commodity and a third share of the second trading commodity exchanged according to the second numerical value; and
updating, by the server, the updated account information of the user according to the information about the second trading commodity again.

8. The method according to claim 6, wherein after the processing, by the server, the updated account information of the user according to the transaction request message, the method further comprises:
if the server determines that the share of the first trading commodity held by the user before the updating is greater than a first preset value, and that the share of the first trading commodity held by the user after the updating is less than a second preset value,
determining, by the server, a second numerical value corresponding to the share of the first trading commodity held by the user after the updating, and determining, according to the second numerical value, information about a second trading commodity to be exchanged, wherein the information about the second trading commodity comprises: an identification of the second trading commodity and a third share of the second trading commodity exchanged according to the second numerical value; and
updating, by the server, the updated account information of the user according to the information about the second trading commodity again.

9. A server, comprising: a processor, a memory and a receiver;
wherein the memory is configured to store executable instructions of the processor;
the processor is configured to:
acquire a first numerical value corresponding to consumption data of a user;
determine information about a first trading commodity to be exchanged according to the first numerical value, wherein the information about the first trading commodity comprises: an identification of the first trading commodity and a first share of the first trading commodity exchanged according to the first numerical value;
update account information of the user according to the information about the first trading commodity;
the receiver is configured to receive a transaction request message transmitted by the user, wherein the transaction request message comprises the identification of the first trading commodity, an operation type corresponding to the first trading commodity and a second share of the first trading commodity corresponding to the operation type, wherein the operation type corresponding to the first trading commodity is: buy or sell; and
the processor is further configured to process the updated account information of the use according to the transaction request message.

10. The server according to claim 9, wherein the processor is specifically configured to:
determine an attribute parameter of the first numerical value and a numerical value corresponding to each share of the first trading commodity;
determine the identification of the first trading commodity according to the attribute parameter of the first numerical value, and determine the first share of the first trading commodity according to the numerical value corresponding to each share of the first trading commodity,
wherein the attribute parameter of the first numerical value comprises: an identification of a company which generates the first numerical value.

11. The server according to claim 9, wherein,
the processor is specifically configured to update a share of the first trading commodity held by the user in the account information of the user according to the first share of the first trading commodity, if the account information of the user comprises the identification of the first trading commodity;
the processor is specifically configured to add the identification of the first trading commodity into the account information of the user and determine the first share of the first trading commodity as the share of the first trading commodity held by the user, if the account information of the user does not comprise the identification of the first trading commodity.

12. The server according to claim 10, wherein,
the processor is specifically configured to update a share of the first trading commodity held by the user in the account information of the user according to the first share of the first trading commodity, if the account information of the user comprises the identification of the first trading commodity;
the processor is specifically configured to add the identification of the first trading commodity into the account information of the user and determine the first share of the first trading commodity as the share of the first trading commodity held by the user, if the account information of the user does not comprise the identification of the first trading commodity.

13. The server according to claim 11, wherein,
the processor is specifically configured to allocate the second share of the first trading commodity to the account of the user to update the share of the first trading commodity held by the user, if the operation type corresponding to the first trading commodity is the buy;
the processor is specifically configured to exchange the second share of the first trading commodity for capital information and allocate the capital information to the account of the user to update the share of the first trading commodity held by the user, if the operation type corresponding to the first trading commodity is the sell.

14. The server according to claim 12, wherein,
the processor is specifically configured to allocate the second share of the first trading commodity to the account of the user to update the share of the first trading commodity held by the user, if the operation type corresponding to the first trading commodity is the buy;
the processor is specifically configured to exchange the second share of the first trading commodity for capital information and allocate the capital information to the account of the user to update the share of the first trading commodity held by the user, if the operation type corresponding to the first trading commodity is the sell.

15. The server according to claim 13, wherein,
if the processor determines that the share of the first trading commodity held by the user before the updating is greater than a first preset value, and that the share of the first trading commodity held by the user after the updating is less than a second preset value,
the processor is further configured to:
determine a second numerical value corresponding to the share of the first trading commodity held by the user after the updating, and determine, according to the second numerical value, information about a second trading commodity to be exchanged, wherein the information about the second trading commodity comprises: an identification of the second trading commodity and a third share of the second trading commodity exchanged according to the second numerical value; and
update the updated account information of the user according to the information about the second trading commodity again.

16. The server according to claim 14, wherein,
if the processor determines that the share of the first trading commodity held by the user before the updating is greater than a first preset value, and that the share of the first trading commodity held by the user after the updating is less than a second preset value,
the processor is further configured to:
determine a second numerical value corresponding to the share of the first trading commodity held by the user after the updating, and determine, according to the second numerical value, information about a second trading commodity to be exchanged, wherein the information about the second trading commodity comprises: an identification of the second trading commodity and a third share of the second trading commodity exchanged according to the second numerical value; and
update the updated account information of the user according to the information about the second trading commodity again.
